(19) United States
(12) Patent Application Publication
(10) Pub. No.: US 2017/0129025 A1
(43) Pub. Date: May 11, 2017

(54) Saw

(71) Applicant: Black & Decker Inc., New Britain, CT (US)

(72) Inventors: Matteo Mortaro, Marsciano (IT); Lucio Ginocchini, San Sisto (IT); Marcello Bettacchini, Ellera di Corciano (IT)

(21) Appl. No.: 15/333,358

(22) Filed: Oct. 25, 2016

(30) Foreign Application Priority Data
Nov. 6, 2015 (GB) 1519661.1

(51) Int. Cl. B23D 45/04; B27B 5/18

(52) U.S. Cl. CPC B23D 45/042; B27B 5/185

(57) ABSTRACT

A saw for performing chop cuts has a base, a cutting unit, and a pivot joint pivotally mounting the cutting unit to the base to enable the cutting unit to pivot towards or away from the base to perform chop cuts. The pivot joint has a cup-shaped section having an open end, a cap rotatably mounted on the open end of the cup-shaped section to form a sealed enclosed space within the cup-shaped section and cap, and a spring located inside of the sealed enclosed space. The spring is connected between the cup-shaped section and the cap. The spring applies a rotational biasing force between the cup-shaped section and the cap to urge relative rotation movement between the two.

### FIELD OF THE INVENTION

The present invention relates to a saw with a pivot joint.

### BACKGROUND

U.S. Pat. No. 5,720,096 discloses a typical chop saw. A chop saw typically includes a base. A motor unit is attached to one end of an arm which is pivotally mounted at the other end to a rear edge of the base via a pivot joint. The motor unit comprises an electric motor which rotationally drives a circular saw blade mounted on a spindle which projects from the motor unit. The motor unit is biased to an upper position by a spring within the pivot joint. The motor unit can be pivoted downwards towards the base by an operator grasping a handle attached to the motor unit and urging it downwards against the biasing force of the spring. The motor is activated by the operator using a switch mounted on the handle, the motor being typically powered by a mains electricity supply.

The work piece to be cut is placed on the base against a fence located towards the rear of the base. The work piece may be clamped against the fence using an adjustable clamp. Such clamps are typically attached to the base. Guards, attached to the motor unit, may surround part or all of the blade. A guard actuation mechanism may be utilized in order to retract the guards when the motor unit is pivoted downwardly. When the motor is activated and a work piece is secured on the base, the motor unit is pivoted downwards towards the base by an operator to perform a chop cut on the work piece.

Other types of saw incorporate a pivot joint to enable the saws have a chopping function and perform chop cuts, for example, a sliding compound miter saw. Such saws also require a pivot joint to enable the saw to perform chop cuts. EP2689880 discloses an example of such a saw and which has a pivot joint to enable it to perform chop cuts.

One problem with using chop saws or saws with a chopping function is that they generate a lot dust and debris during the cutting process. In existing designs of pivot joints used on such saws, the build-up of dust and debris in and around the pivot joint can interfere with the operation of the pivot joint. It is therefore intended to provide an improved design of pivot joint.

### BRIEF DESCRIPTION OF THE DRAWINGS

FIG. 1 shows a perspective view of a miter saw;

FIG. 2 shows an exploded view of the pivot joint of the miter saw from a first perspective;

FIG. 3 shows an exploded view of the pivot joint from a second perspective;

FIG. 4 shows an exploded view of the spring and cup-shaped section; and

FIG. 5 shows a schematic diagram of a cross sectional view of the pivot joint.

### DESCRIPTION

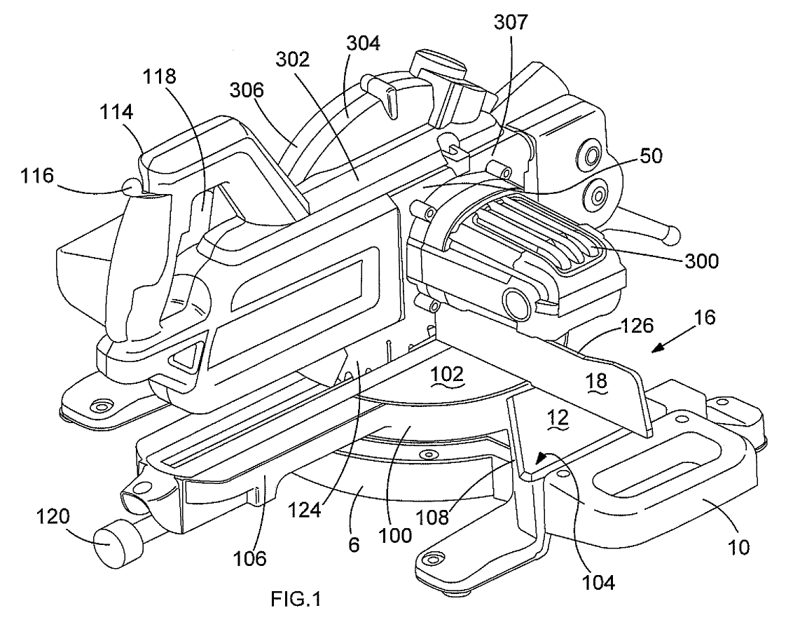

Referring to FIG. 1, the miter saw comprises a base assembly comprising a base 6 and a rotatable table 100. The base 6 preferably has two platforms 12 formed symmetrically on either side of the base 6. The rotatable table 100 is preferably rotatably mounted on the base 6 between the two platforms 12. The top surface 102 of rotatable 100 preferably lies flush with the top surfaces 104 of the two platforms 12. The combined surfaces 102, 104 of the rotatable table 100 and platforms 12, respectively, may form a work surface.

An extension arm 106 is rigidly attached to the rotatable table 100 which extends forward in well-known manner. The rotatable table 100 and extension arm 106 can pivot about a vertical axis through a range of angular positions. The angular movement is preferably restricted by the extension arm 106 engaging with one or other of the sides 108 of the platforms 12.

A locking lever 120 can be used to lock the rotatable table 100 and extension arm 106 in desired angular positions. A scale 122 is attached to the base 6 to indicate the angular position of the extension arm 106. Carrying handles 10 are attached to the sides of the base 6.

A mount 27 is preferably pivotally mounted on the rear of the rotatable table 100. Two guide rods (not shown) may be pivotally attached to the mount 27. A cutting unit 50 may be mounted to the mount 27 and/or slideably mounted on the two guide rods. Cutting unit 50 preferably includes a motor housing 68 in which is mounted an electric motor (not shown), guide rod support housing 110 in which are slideably mounted the two guide rods, and a blade guard 112 which surrounds a cutting blade 124 which is mounted on an output spindle (not shown) of the motor. The mount 27 can pivot about a horizontal axis on the rotatable table to enable the saw to perform bevel cuts. The rods can pivot on the mount about a horizontal axis to move the two rods and the cutting unit 50 vertically away from or towards the rotatable table 100 and extension arm 106 to enable the saw to perform chop cuts.

A spring 204, which forms part of the pivot joint, preferably biases the mount 27 and guide rods to their highest position. A handle 114 may be attached to the front of the cutting unit 50 by which a user moves the cutting unit 50 towards or away from the rotatable table 100 and extension arm 106. The mount 27 preferably locks in automatically its uppermost pivotal position by a latch mechanism (not shown). A pivotal lever 116 may be mounted on the handle 114 by which an operator can release the latch mechanism. A switch 118 is preferably mounted on the handle 114, the depression of which activates the electric motor.

A fixed fence 16 is preferably rigidly attached on top of the two platforms 12 of the base 6 at the rear of the platforms 12. The fence 16 preferably extends across the rotatable table 100 but does not interfere with its rotational movement.

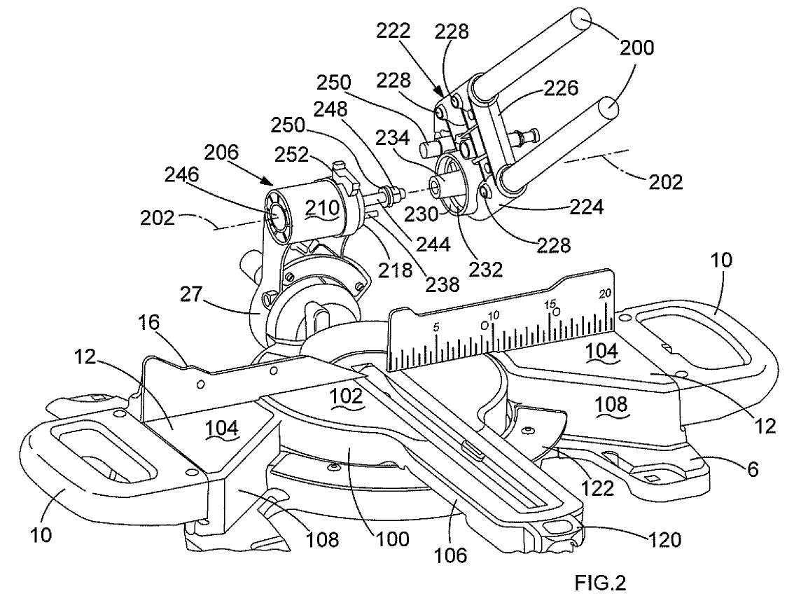

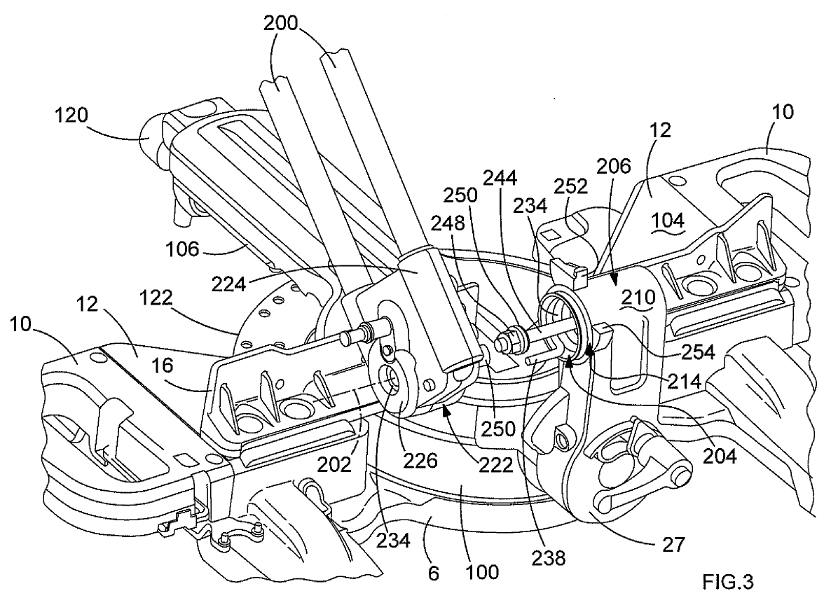

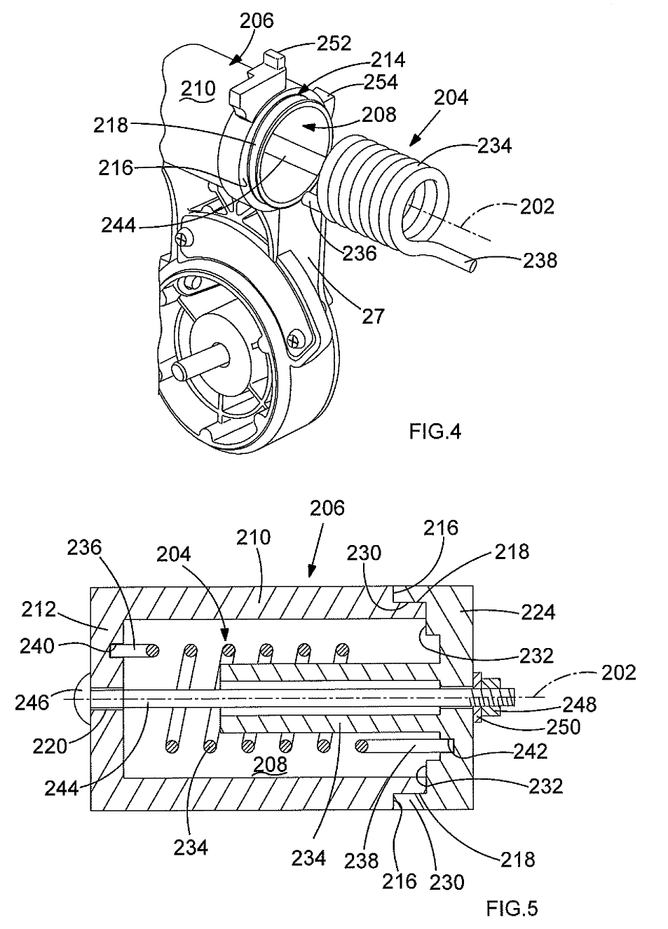

The pivot joint will now be described in more detail with reference to FIGS. 2 to 5.

The mount 27, which is preferably manufactured from aluminum, comprises a curved wall 210 sealed at one end by an end wall 212 to form a cup-shaped section 206 enclosing a tubular passage 208 of uniform circular cross-section. Two walls 216, 218 may be formed around the open end of the cup-shaped section 206 to form a groove 214. An aperture 220 is preferably formed through the center of the end wall 212.

A base 222 is preferably attached to the end of the two guide rods 200 to hold the two guide rods 200 in position. The base 222 preferably comprises two metal clam shells 224, 226 which are clamped around the end of the guide rods 200 and secured to each other and the guide rods using bolts 228.

One of the clam shells 224 preferably comprises a circular wall 230 which connects to a circular base 232 formed on the side of the clam shell 224. The size and dimensions of the circular wall 230 are such that it is capable of mating with the groove 214 of the cup-shaped section 206 as best seen in FIG. 5. When the circular wall 230 is mated with the groove 214 of the cup-shaped section 206, the end of the cup-shaped section 206 abuts against circular base 232.

An elongate tube 234 preferably extends from the clam shell 224 at the center of the circular wall 230 and in parallel to the circular wall 230. When the circular wall 230 is mated with the groove 214 of the cup-shaped section 206, the tube 234 preferably extends into the tubular passage 208 as best seen in FIG. 5.

The pivot joint also includes the spring 204 which has a central coiled section 234 and two straight ends 236, 238. When the pivot joint assembled, the circular wall 230 is preferably mated with the groove 214 of the cup-shaped section 206. The spring 204 is preferably located inside of the tubular passage 208 with the coiled section surrounding the tube 234.

One of the straight ends 236 preferably locates within a recess 240 formed in the end wall 212 of the cup-shaped section 206 to attach it to the cup-shaped section 206. The other straight end 238 preferably locates in a second recess 242 formed in the clam shell 224 inside of the circular base 232 to attach it to the clam shell 224.

A bolt 244 may be passed through the aperture 220 in the end wall 212 and through the tube 234. The head 246 of the bolt 244 preferably locates against the outside of the end wall 212. A nut 248 and a washer 250 are preferably screwed on the free end the bolt 244 and abut against the end of the elongate tube as best seen in FIG. 5. The bolt 244 preferably secures the cup-shaped section 206 to the circular wall 230 with the circular wall 230 mated with the groove 214 of the cup-shaped section 206. When the bolt 244 secures the cup-shaped section 206 to the circular wall 230, the clam shell 224 in combination with the cup-shaped section 206 preferably form a sealed enclosed space 208 in which the spring 204 is located. The longitudinal axis of the bolt 244 is preferably co-axial with the axis 202 of rotation.

The base 222 can pivot on the mount 27 about axis 202 by the circular wall 230 rotating around the groove 214 while remaining mated to it. As the base 222 pivots on the mount 27, the cup-shaped section 206 and/or the circular wall 230 rotates around the bolt 244. The base 222 is pivotally supported on the mount 27 by the engagement of circular wall 230 and the groove 214. As the circular wall 230 rotates within the groove 214, one straight end 236 of the spring 204 rotates relative to the other end 238, storing a spring force in the coiled section 234. The spring 204 applies a biasing force between the cup-shaped section 206 and the clam shell 224. The spring 204 is arranged to urge the two guide rods 200 to urge them to point upwardly and move the cutting unit 50 to its highest position. The angular movement of the base 222 on the mount 27 is limited by a projection 250 on the base 222 travelling between two end stops 252, 254 as the base 222 pivots on the mount 27. The spring 204 preferably remains under tension regardless of the relative angular positions of the base 222 and the mount 27.

While the present invention has been described in relation to a sliding compound miter saw, it will be appreciated that it is applicable to any saw where a pivot joint is required to enable the saw to perform chop cuts.

1. A saw for performing chop cuts comprising:
a base;
a cutting unit;
a pivot joint pivotally mounting the cutting unit to the base to enable the cutting unit to pivot towards or away from the base to perform chop cuts, the pivot joint comprising:
a cup-shaped section having an open end;
a cap rotatably mounted on the open end of the cup-shaped section to form a sealed enclosed space within the cup-shaped section and cap; and
a spring located inside of the sealed enclosed space and connected between the cup-shaped section and the cap, the spring applying a rotational biasing force between the cup-shaped section and the cap to urge relative rotation movement between the two.

2. The saw of claim 1 wherein relative rotation between the cup-shaped is section and the cap in one direction increases the biasing force applied by the spring.

3. The saw of claim 2 wherein the spring always remains under tension regardless of the relative angular positions of the cup-shaped section and cap.

4. The saw of claim 1 wherein the cup-shaped section comprises a curved wall sealed at one end with an end wall to form a tubular passage.

5. The saw of claim 1 wherein a circular groove is formed around the open end of the cup-shaped section, the groove mating with the cap when the cap is mounted on the open end of the cup-shaped section.

6. The saw of claim 5 wherein the cap is rotatably mounted on the cup-shaped section.

7. The saw of claim 1 wherein the spring) is a helical spring comprising a coiled central section having two ends, one end being connected to the cup-shaped section and the other end being connected to the cap.

8. The saw of claim 7 wherein the cap is retained on the cup-shaped section.

9. The saw of claim 8 wherein at least one of the cup-shaped section and the cap rotates around the bolt as the cap rotates on the cup-shaped section.

10. The saw of claim 7 wherein the cap comprises an elongate tube which projects into the sealed enclosed space, the coiled central section of the spring encircling the tube and the bolt passing through the tube.
